(19) United States
(12) Patent Application Publication
(10) Pub. No.: US 2001/0052862 A1
(43) Pub. Date: Dec. 20, 2001

(54) Security system simulates patterns of usage of appliances

(75) Inventor: Gregory Robert Roelofs, San Jose, CA (US)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 09/886,079

(22) Filed: Jun. 20, 2001

Related U.S. Application Data
(60) Provisional application No. 60/212,578, filed on Jun. 20, 2000.

(51) Int. Cl. G08B 21/00

(52) U.S. Cl. 340/999

(57) ABSTRACT

A security system for a home simulates usage of appliances to give the impression that someone is present. The system comprises a monitor for monitoring events indicative of state changes of the appliances during operational use of the appliance by a user; a storage for storing information about the events; an information processing component for creating a temporal pattern of usage based on the stored information; and a control interface for controlling the appliance according to the pattern in the absence of the user.

### FIELD OF THE INVENTION

The invention relates to a security system, especially but not exclusively for home owners or shop keepers.

### BACKGROUND ART

Security systems are known that switch on/off lights in the house to give the impression to a casual passer-by that someone is at home. The known systems are based on static timers. These timers have to be inserted between the lights and the power lines, and they have to be set individually by the user.

Home automation systems are known, e.g., based on X-10, for remote control of appliances. An X-10 network has modules, X-10 transmitters and X-10 receivers, that communicate via the standard household power lines. The modules are plugged into the electrical outlets. The transmitters send commands such as “turn on”, “turn off” or “dim”, in combination with the address of the receiver unit to be controlled. This broadcast goes out over the electrical wiring in a building. Each receiver is set to a certain unit address. The receiver responds to commands having the proper address and ignores commands that do not have the proper address. Two-way X-10 appliance modules are available that enable to verify whether a device was turned on or turned off. Computer interfaces that can generate a status request receive an X-10 signal back from the device addressed that indicates its status is “on” or “off”.

### SUMMARY OF THE INVENTION

The invention relates to a security system for enabling to simulate usage of at least one appliance. The system comprises a monitor for monitoring events indicative of state changes of the appliance during operational use of the appliance by a user. The system further comprises a storage for storing information about the events; an information processing component for creating a temporal pattern of usage based on the stored information; and a control interface for controlling the appliance according to the pattern, for example in the absence of the user. The invention uses the home control network to replicate typical usage patterns of lighting, audio, video, sprinkler or other selected equipment throughout the home or shop as if the user were there, e.g., while the owner is on vacation. The server records information about typical usage patterns and creates a basis for an inventory of typical patterns. The information recorded comprises, e.g., the state changes per device and the time stamps, or the commands initiated by the user to control the appliances, together with time stamps, etc. The information is used to re-create usage patterns for playing back, e.g., in a random order, the recorded patterns or variations thereof. An advantage of the invention is a more ergonomic configuration of the security system as the patterns are automatically recorded, and reflect the weekly or gradual seasonal changes in typical usage patterns.

The invention also relates to a method of providing security service The method comprises enabling a party (home owner, shop-keeper, office manager, etc.) to register equipment (e.g., lights, audio equipment) controllable through a network. Once registered, the control profile of the equipment is known. Upon request of the party, the service controls the equipment via the network according to a pattern so as to simulate presence of a user. The pattern may change from day to day, or weekly and may have a gradual trend to take seasonal changes into account. The service may also supply data from a data base that is representative of typical usage as if the user were present. The user can download or otherwise install this data on his/her home network to be used by a control application when the system is set into the security mode. XML is a suitable format for such data.

As aspects of the invention can also be fully implemented in software, the invention also relates to a software application for being installed on a security system to enable to simulate usage of a networked appliance. The software application controls monitoring events indicative of state changes of the appliance during operational use of the appliance by a user; storing information about the events; creating of a temporal pattern of usage based on the stored information; and enabling to control the appliance according to the pattern.

### BRIEF DESCRIPTION OF THE DRAWING

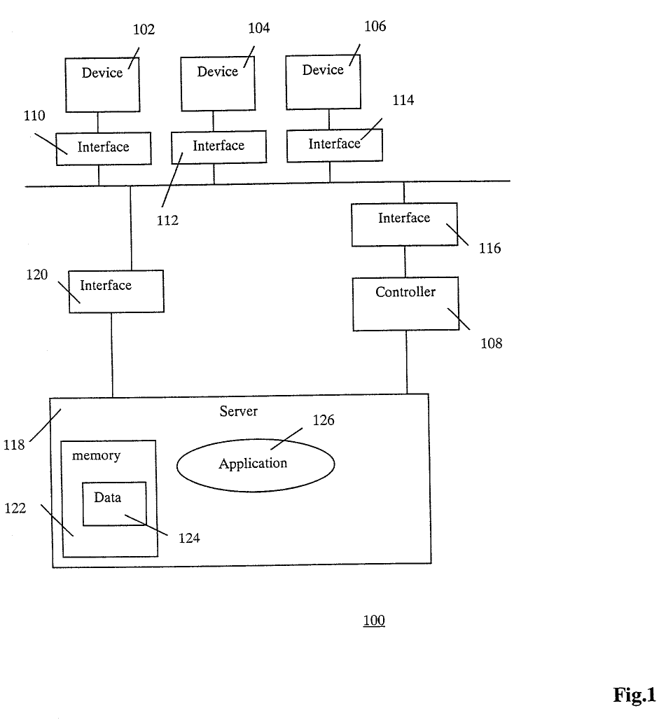

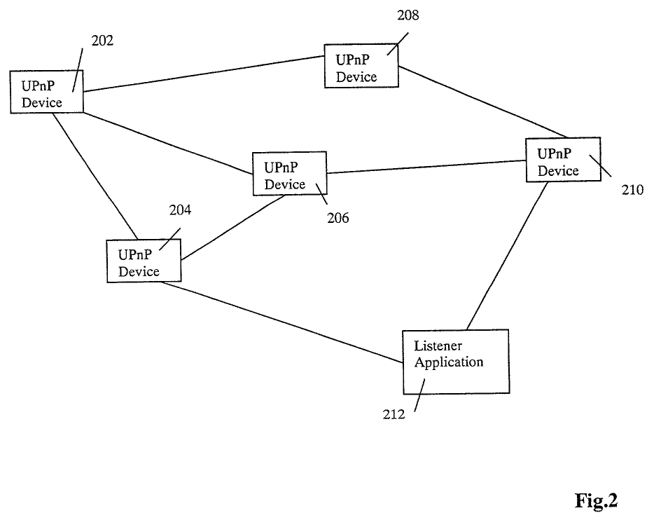

The invention is explained below in more detail, by way of example and with reference to the accompanying drawing, wherein FIGS. 1 and 2 are block diagrams of a system in the invention

### DETAILED EMBODIMENTS

FIG. 1 is a block diagram of a system 100 in the invention. System 100 comprises appliances or devices 102, 104, . . . , 106. For example, device 102 comprises a lamp, device 104 comprises a TV set, and device 106 comprises an electric motor to automatically open or close a curtain. Devices 102-106 are connected to a controller 108 via control interfaces 110, 112, 114 and 116. For example, devices 102-106 are connected to controller 108 via the power lines, the interfaces 110-116 comprising X-10 modules.

When devices 102-106 are in operational use, they receive control commands from the user. For example, the user manipulates a remote control device that sends an IR or RF command or flips a switch to change the state a specific one of devices 102-106, e.g., using the X-10 network.

System 100 further comprises a server 118 connected to the control network through an interface 120. Server 118 monitors the states of devices 102, 104, . . . , 106 or the associated commands that caused the state changes, for extracting a pattern of usage. A pattern comprises, for each of devices 102-106, e.g., the day of the week and the times of the day at which a respective one of devices 102-106 was caused to change states in response to a command from the user, together with the specific state change and or command. This is implemented, for example through a polling mechanism that checks the state of each of devices 102-106 per time interval, e.g., per interval of five minutes, or through an interrupt mechanism under which devices 102-106 broadcast or otherwise notify server 118 when their state has changed. Server 118 stores, per device 102-106, information indicative of the state changes and the associated time stamps in a memory 122. Memory 122 thus comprises data 124 from which a collection of daily patterns of usage of devices 102-106 can be extracted. For example, the collection comprises patterns identically as recorded, or variations thereof, e.g., by time-shifting the events as recorded, or created by statistical analysis of the recorded information. A software application 126 then takes these patterns as input for control of devices 102-106, e.g., via controller 108 or via interface 120, using the proper commands associated by the state changes specified by the patterns used.

Alternatively, server 108 monitors the commands that get broadcast on the X-10 network. The commands cause state changes of the addressed device(s) and are thus indicative of the state changes. The patterns to be simulated then can be re-created through the proper sequences of commands, either as recorded or as generated based on the recorded patterns.

FIG. 2 is a block diagram of a system 200 in the invention. System 200 comprises a UPnP network of devices 202-210. UPnP stands for Universal Plug and Play and refers to a standard that uses Internet and Web protocols. UPnP enables devices such as PCs, peripherals, intelligent appliances, and wireless devices to be plugged into a network and automatically discover and control each other. When a device gets plugged into the network, the device configures itself, acquires a TCP/IP address, and uses a discovery protocol based on the Internet's Hypertext Transfer Protocol (HTTP) to announce its presence on the network to other devices. For example, the user flips a UPnP wall switch. The switch is a UPnP service, whose state is defined by a variable called “Position.” When the switch is flipped, “Position” changes from “Off” to “On”. This can be used to activate a script running on PC. When the script receives the message that the position of the switch has changed to “On”, the script causes, for example, light 102 to turn on, it TV set 104 to turn on and to be tuned to a pre-determined channel, and it also causes the curtains 106 to be drawn. For more information on UPnP see, e.g., the white paper “Understanding Universal Plug and Play”, Microsoft Windows ME, of June 2000, available on the Web.

A listener application 212 can monitor devices 202-210, or a subset thereof, e.g., if not all devices have behavior or functionality that contributes or is needed to create the impression that someone is at home when the devices change state in the pattern simulation mode. Listener application 212 subscribes to these devices and is then capable of monitoring the SOAP (Simple Access Object Protocol) commands that UPnP uses in an XML protocol over http for remote procedure calls. The commands or a selection thereof could be logged and used in simulation patterns. If the state changes are used for logging, the SOAP commands can be re-engineered that caused the state changes. Alternatively, a listener can be added to every device to determine the state changes or commands. This option may be desirable when some devices communicate with each other using a proprietary protocol. Alternatively, a sniffer application monitors all IP traffic and determines the relevant devices and services based on their IP address to extract the patterns. It is clear to the person skilled in the art of UPnP that there are various ways to determine information about a usage pattern and to use this information to create and use patterns in the simulation mode of the system.

The home automation or home control technologies based on X-10 and UPnP are discussed here by way of example. Other such technologies, e.g., Jini or HomeRF, are feasible as well under the proper circumstances. In a hybrid network, i.e., a network using more than one such technology, bridges allow one part of the network to be represented as an entity on another network part, and enable to use the invention for the network as a whole.

Incorporated herein by reference are the following:

U.S. Ser. No. 09/519,546 filed Mar. 6, 2000 for Erik Ekkel et al., for PERSONALIZING CE EQUIPMENT CONFIGURATION AT SERVER VIA WEB-ENABLED DEVICE. This document relates to facilitating the configuring of CE equipment by the consumer by means of delegating the configuring to an application server on the Internet. The consumer enters his/her preferences in a specific interactive Web page through a suitable user-interface of an Internet-enabled device, such as a PC or set-top box or digital cellphone. The application server generates the control data based on the preferences entered and downloads the control data to the CE equipment itself or to the Internet-enabled device.

U.S. Ser. No. 09/852,467 filed May 9, 2001 for Eugene Shteyn for DEVICE IDENTIFICATION AND CONTROL IN NETWORK ENVIRONMENT. This document relates to a control network for home appliances. The network comprises a module for interfacing an appliance to the network. The module adopts the identity of the appliance when the module and the appliance are being interconnected. The appliance comprises a tag, e.g., in its power plug, with identifying information that gets read by the module and transferred to a controller. The module itself can have a location dependent identifier to enable topology dependent software applications.

U.S. Ser. No. 09/165,683 filed Oct. 2, 1998 for Eugene Shteyn CALLS IDENTIFY SCENARIO FOR CONTROL OF SOFTWARE OBJECTS VIA PROPERTY ROUTES. This document relates to an information processing system with first and second physical components represented by first and second software objects. Both objects have properties that are changeable through calls to the objects. The system enables registering a property route linking a first property of the first object to a second property of the second object so that a change in the first property causes the second call being issued to the second object upon invoking the property route. The input call to the first object comprises an identifier enabling to conditionally invoke the route. In this manner, routes belonging to different scenarios are being kept independent so that the system operates more reliable that without scenario identifiers.

What is claimed is:

1. A security system for enabling to simulate usage of at least one appliance, the system comprising:
a monitor for monitoring events indicative of state changes of the appliance during operational use of the appliance by a user;
a storage for storing information about the events;
an information processing component for creating a temporal pattern of usage based on the stored information; and
a control interface for controlling the appliance according to the pattern.

2. The system of claim 2, wherein the information comprises data representative of the state changes and of associated time-stamps.

3. The system of claim 3, wherein the information comprises data representative of commands sent during the operational use that caused the state changes and of associated time-stamps.

4. In a security system, a method of enabling to simulate usage of a networked appliance, the method comprising:
monitoring events indicative of state changes of the appliance during operational use of the appliance by a user;
storing information about the events;
creating a temporal pattern of usage based on the stored information; and
enabling to control the appliance according to the pattern.

5. A data base with data representative of typical usage patterns of appliances for control of at least a specific appliance in order to simulate a presence of a user.

6. A method of providing a security service, the method comprising:
enabling to register equipment controllable through a network;
controlling the equipment via the network according to a pattern so as to simulate presence of a user.

7. A software application for being installed on a security system to enable to simulate usage of a networked appliance, the software controlling:
monitoring events indicative of state changes of the appliance during operational use of the appliance by a user;
storing information about the events;
creating of a temporal pattern of usage based on the stored information; and
enabling to control the appliance according to the pattern.
